(19) United States
(12) Patent Application Publication
(10) Pub. No.: US 2015/0136766 A1
(43) Pub. Date: May 21, 2015

(54) EXPANDABLE TRASH RECEPTACLE

(71) Applicant: Dana Marie Rivas, Jessup, MD (US)

(72) Inventor: Dana Marie Rivas, Jessup, MD (US)

(21) Appl. No.: 14/333,930

(22) Filed: Jul. 17, 2014

Related U.S. Application Data
(60) Provisional application No. 61/906,291, filed on Nov. 19, 2013.

(51) Int. Cl. B65D 21/08; B65F 1/02; B65D 25/28

(52) U.S. Cl. CPC B65D 21/086; B65D 25/2897; B65F 1/02
USPC 220/8

(57) ABSTRACT

An expandable trash receptacle is provided. The expandable trash receptacle includes a base receptacle and a sliding receptacle. The base receptacle and sliding receptacle may each include at least one sidewall having a top end and a bottom end. The base receptacle may have an opening formed at the top end and a base portion formed at the bottom end. The sliding receptacle may include an opening formed at the top end and bottom end, leading into the sliding receptacle. The sliding receptacle slidably engages the base receptacle and is extendable therefrom.

### CROSS-REFERENCE TO RELATED APPLICATION

This application claims the benefit of priority of U.S. provisional application No. 61/906,291, filed Nov. 19, 2013, the contents of which are herein incorporated by reference.

### BACKGROUND OF THE INVENTION

The present invention relates to a trash receptacle and, more particularly, to an expandable trash receptacle.

In order to keep the home looking neat and clean it is common to place a household trash receptacle under cabinets and hidden away. Further, families with young children may place the household trash receptacle under a baby proofed cabinet. Using a smaller trash receptacle is usually enough for the immediate family. However, the problem arises when friends and extended family are over for celebrations. Trash receptacles within cabinets are generally too small for large gatherings. The trash receptacle is in an inconvenient area for a large group and trash quickly starts spilling over. Therefore, larger trash receptacles are needed for such occasions. However, purchasing more than one trash receptacle is costly and inconvenient.

As can be seen, there is a need for a trash receptacle that may be used for large gatherings, and may be hidden away during household use.

### SUMMARY OF THE INVENTION

In one aspect of the present invention, an expandable trash receptacle comprises: a base receptacle comprising at least one sidewall having a top end and a bottom end, wherein the top end forms an opening leading into the base receptacle and the bottom end comprises a base portion; a sliding receptacle comprising at least one sidewall having a top end and a bottom end, wherein the top end and the bottom end form an opening leading into the sliding receptacle, wherein the sliding receptacle slidably engages the base receptacle and is extendable therefrom.

These and other features, aspects and advantages of the present invention will become better understood with reference to the following drawings, description and claims.

### BRIEF DESCRIPTION OF THE DRAWINGS

FIG. 1 is a perspective view of the present invention in a retracted position;

FIG. 2 is a side elevation view of the present invention in an expanded position;

FIG. 3 is a front elevation view of the present invention in an expanded position;

FIG. 4 is an exploded perspective view of the present invention; and

FIG. 5 is a detail perspective view of the latch of the present invention, indicated by line 5-5 of FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes an upward expanding household trash container, including two usable, working sizes within one container. The present invention includes a large size and a smaller sized trash receptacle within one container. The container in its collapsed state is a smaller sized trash receptacle that may be used under a cabinet, keeping the household looking neat and tidy.

This same receptacle expands upward, locking in place as a larger sized trash receptacle. The present invention may therefore be removed from under the cabinet, expanded up to its larger size and placed in an open visible area for when guests are over.

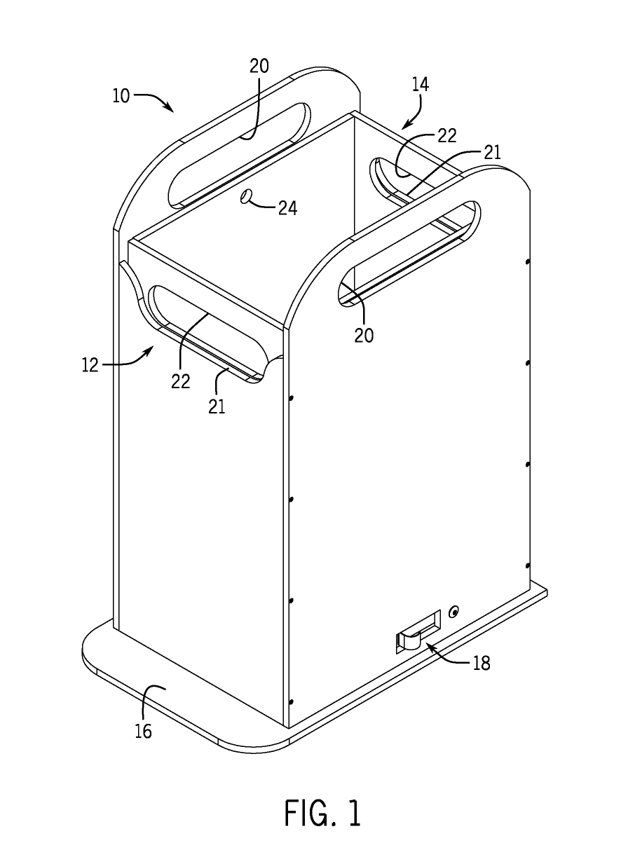

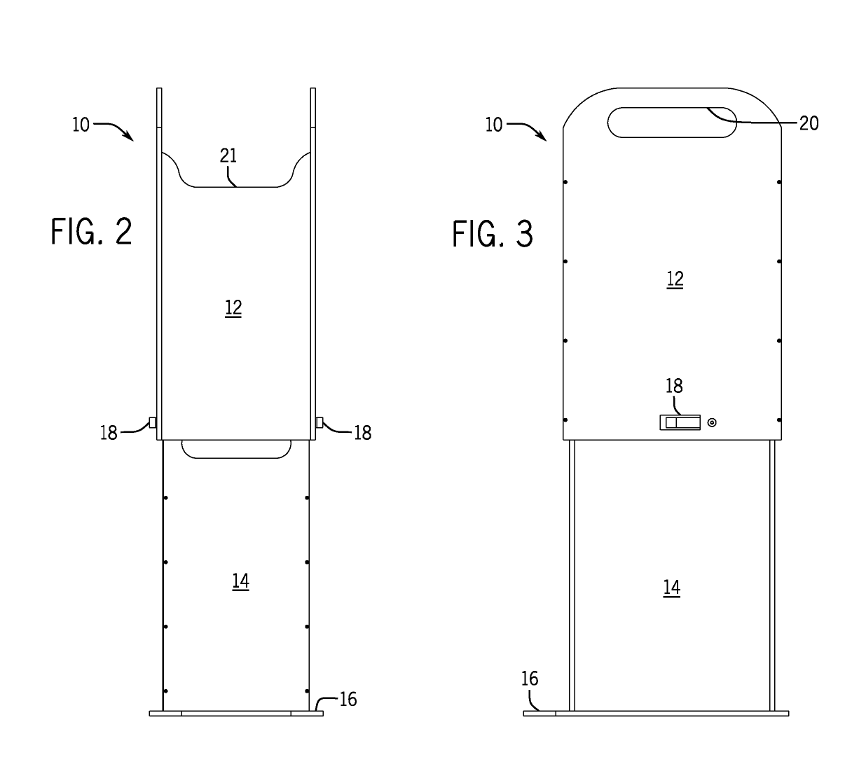

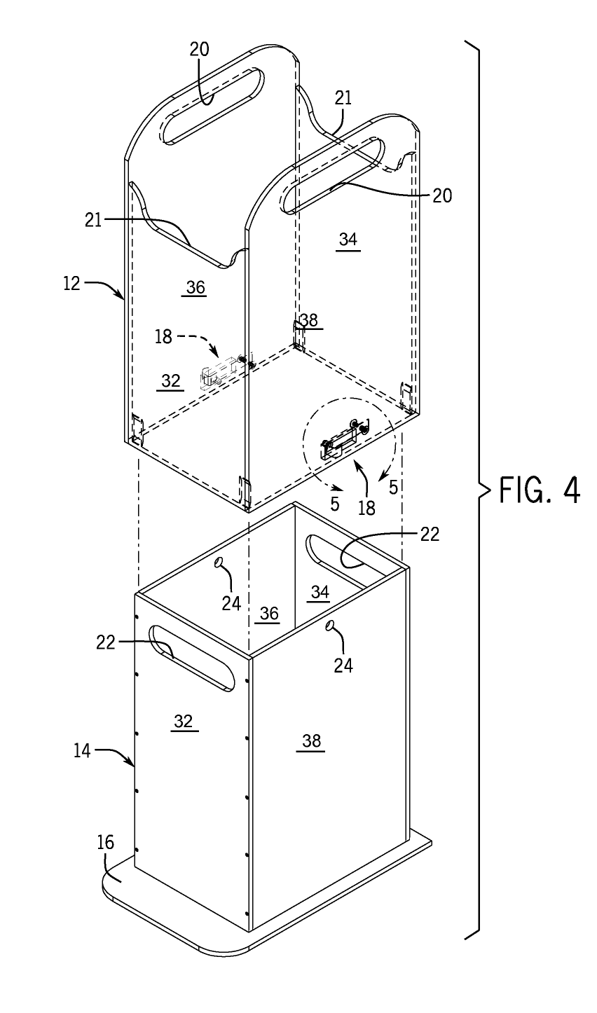

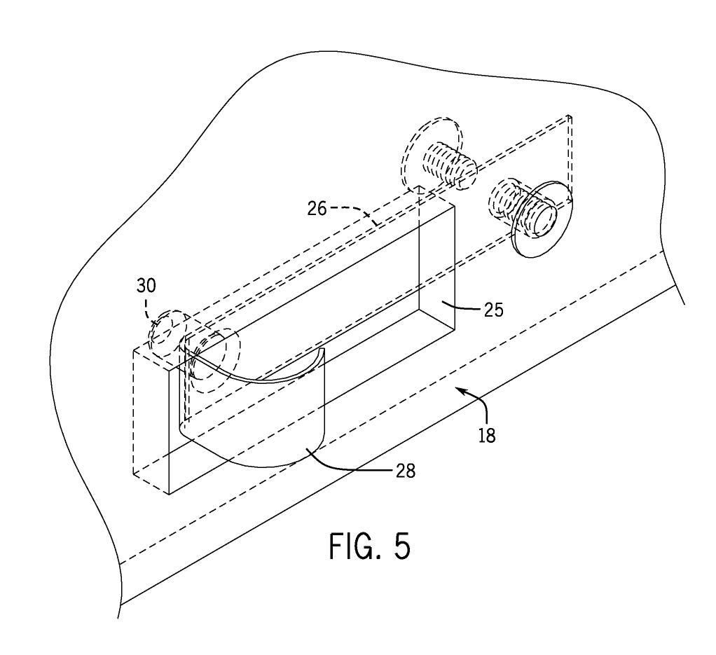

Referring to FIGS. 1 through 5, the present invention includes an expandable trash receptacle 10. The expandable trash receptacle 10 includes a base receptacle 14 and a sliding receptacle 12. The base receptacle 14 and sliding receptacle 12 may each include at least one sidewall having a top end and a bottom end. The top end of the base receptacle 14 may form an opening leading into the base receptacle 14. The bottom end of the base receptacle 14 may include a base portion 16 that may rest on a surface. The sliding receptacle 12 may include an opening formed at the top end and bottom end, leading into the sliding receptacle 12.

The sliding receptacle 12 slidably engages the base receptacle 14 and is extendable therefrom. As such, the expandable trash receptacle 10 may include a fixed expanded position and a fixed retracted position. The fixed expanded position may include the sliding receptacle 12 extending from the base receptacle 14 creating a larger trash receptacle. The fixed retracted position includes the sliding receptacle 12 and the base receptacle 14 substantially overlapping, creating a smaller trash receptacle. The expanded position includes the bottom end of the sliding receptacle 12 oriented at a greater distance from the bottom end of the base receptacle 14 as compared to the fixed retracted position.

As mentioned above, the at least one sidewall of the sliding receptacle 12 overlaps the at least one sidewall of the base receptacle 14, slidably engaging one another. In certain embodiments, the sidewall of the base receptacle 14 and the sliding receptacle 12 may include four sides, including a first side 36, a second side 38, a third side 32 and a fourth side 34. Further, in certain embodiments, the base portion 16 of the base receptacle 14 may extend passed the perimeter of the sidewall of the base receptacle 14. Therefore, the bottom end of the sliding receptacle 12 may rest against the base portion 16 in the retracted position. Further, a user may place a foot on the base portion 16 that extends passed the perimeter of the sliding receptacle 12 to keep the receptacle securely on the floor when pulling upward to expand the expandable receptacle 10.

In certain embodiments, the sliding receptacle 12 may include a handle 20 at the top end on the first side 36 and the second side 38. Further, the sliding receptacle 12 may include a recess 21 on the third side 32 and the fourth side 34. The handles 20 of the sliding receptacle 12 may protrude passed the top end of the base receptacle 14, even in the retracted position. The base receptacle 14 may include a handle 22 at the top end of the third side 32 and fourth side 34, each protruding passed the recesses 21 of the sliding receptacle 12 in the retracted position. Therefore, a user may easily grasp the handles 22 of the base receptacle 14 to pick-up and move the trash receptacle 10 while it's in the retracted position. Further, a user may grasp the handles 20 of the sliding receptacle 12 and pull upward to expand the trash receptacle 10 from the retracted position to the expanded position.

In certain embodiments, the expandable trash receptacle 10 may be fixed in the expanded position by a latch 18. The latch 18 may include at least one spring biased pin 30 formed to fit within a pin hole 24. In certain embodiments, the latch 18 may be at the bottom end of the sliding receptacle 12 and the pin hole 24 may be at the top end of the base receptacle 14. A latch opening 25 may formed through the bottom end of base receptacle 14. A flexible element 26 may be attached to the inner surface of the sliding receptacle 12, and may include a finger pull latch 28 protruding through the clearance opening 25. On the opposite side of the finger pull latch 28 protruding inward may be the spring biased pin 30. In such embodiments, the sliding receptacle 12 may be pulled upwards until the spring biased pin 30 aligns with and is pushed into the pin hole 24 of the base receptacle 14. When the user is ready to retract the trash receptacle 10, the user may pull the spring biased pin 30 out of the pin hole 24, using the finger pull latch 28, and let the sliding receptacle 12 slide towards the base portion 16. In certain embodiments, the present invention may include two latches 18 disposed on the first side 36 and the second side 38 of the sliding receptacle 12, and two pin holes 24 disposed on the first side 36 and the second side 38 of the base receptacle 14.

It should be understood, of course, that the foregoing relates to exemplary embodiments of the invention and that modifications may be made without departing from the spirit and scope of the invention as set forth in the following claims.

What is claimed is:

1. An expandable trash receptacle comprising:
a base receptacle comprising at least one sidewall having a top end and a bottom end, wherein the top end forms an opening leading into the base receptacle and the bottom end comprises a base portion;
a sliding receptacle comprising at least one sidewall having a top end and a bottom end, wherein the top end and the bottom end form an opening leading into the sliding receptacle,
wherein the sliding receptacle slidably engages the base receptacle and is extendable therefrom.

2. The expandable trash receptacle of claim 1, further comprising a fixed expanded position and a fixed retracted position, wherein fixed expanded position comprises the bottom end of the sliding receptacle oriented at a greater distance from the bottom end of the base receptacle than the fixed retracted position.

3. The expandable trash receptacle of claim 1, wherein the at least one sidewall of the sliding receptacle overlaps the at least one sidewall of the base receptacle.

4. The expandable trash receptacle of claim 3, wherein the sidewall of the base receptacle and the sliding receptacle each comprise a first side, a second side, a third side, and a fourth side.

5. The expandable trash receptacle of claim 4, wherein the sliding receptacle comprises a handle at the top end on the first side and the second side, wherein the third side and the fourth side comprise a recess.

6. The expandable trash receptacle of claim 5, wherein the base receptacle comprises a handle at the top end of the third side and fourth side, each protruding passed the recesses of the sliding receptacle.

7. The expandable trash receptacle of claim 6, wherein the sliding receptacle handles protrude passed the top end of the base receptacle.

8. The expandable trash receptacle of claim 2, further comprising at least one spring biased pin formed to fit within a pin hole in the fixed expanded position.

9. The expandable trash receptacle of claim 8, wherein the spring biased pin is attached to the sliding receptacle near the bottom end, and wherein the pin hole is through the sidewall of the base receptacle near the top end.

10. The expandable trash receptacle of claim 9, further comprising a finger pull latch attached to the spring biased pin and extending from the sidewall of the sliding receptacle.
